(19) United States
(12) Patent Application Publication
(10) Pub. No.: US 2024/0364825 A1
(43) Pub. Date: Oct. 31, 2024

(54) FILM CLAMPING DEVICE

(71) Applicant: Foxlink Image Technology Co., Ltd., New Taipei City (TW)

(72) Inventors: Yun Long Lai, New Taipei City (TW); Chi Cheng Chuang, New Taipei City (TW)

(21) Appl. No.: 18/595,437

(22) Filed: Mar. 5, 2024

(30) Foreign Application Priority Data
Apr. 28, 2023 (CN) 202321031859.X

(51) Int. Cl. H04N 1/00; H04N 1/10

(52) U.S. Cl. CPC H04N 1/0066; H04N 1/1061

(57) ABSTRACT

A film clamping device includes a film holder formed in a flat shape, a cap and a plurality of limiting pads. One side of the film holder defines a first fixing slot vertically penetrating through the film holder. The first fixing slot accommodates a negative film. A dimension of the cap is disposed to be cooperated with a dimension of the first fixing slot so as to be fastened to the film holder. A bottom surface of the cap is provided as a flat surface. The plurality of the limiting pads are made of elastic materials. The plurality of the limiting pads are disposed around a peripheral wall of the first fixing slot.

### CROSS-REFERENCE TO RELATED APPLICATION

The present application is based on, and claims priority from, China Patent Application No. 202321031859.X, filed Apr. 28, 2023, the disclosure of which is hereby incorporated by reference herein in its entirety.

### PRIOR ART

With the rapid development of digital technologies, a storage way of image data has gradually evolved into a digital format storage way. For example, traditional image media are photos, slides, roll films, etc. The traditional image media are able to be scanned by image processing devices to store the traditional image media data in the digital format storage way to become digital format data. The digital format data is able to be actually calculated and modified on a computer. In addition, when transparent documents which are screen sheets, the slides, films and so on are scanned, a transmissive scanner of an optical image processing device is applied to assist a scanning of the optical image processing device. The transmissive scanner projects a ray of light to penetrate through the transparent documents which are to be scanned, so that images on the transparent documents may be converted into digital electronic data by the optical image processing device.

When a conventional optical image processing device scans a transparent document, a film holder needs applying to fasten a position of a positive film or a position of a negative film, and then the film holder is placed on a scanning platform of a scanning device for scanning.

Referring to FIG. 5 to FIG. 7, common-used film holders have different designs according to different film types. A conventional film clamping device 100′ used for fastening a negative film 30′ is shown in FIG. 5. The conventional film clamping device 100′ includes a film holder 10′ and a clamping cap 20′. A negative film slot 11′ is formed in the film holder 10′ for loading the negative film 30′. A middle of the negative film slot 11′ has an isolating rib connected between two inner walls of the negative film slot 11′. When the negative film 30′ is placed on the film holder 10′, the clamping cap 20′ is placed on the negative film 30′ to fasten the negative film 30′. The conventional film clamping device 100′ for fastening a plurality of positive films 40′ is shown in FIG. 6. The conventional film clamping device 100′ includes the film holder 10′, and a plurality of positive film slots 12′ formed in the film holder 10′, so the conventional film clamping device 100′ is able to hold the plurality of the positive films 40′ at the same time. Therefore, when the plurality of the positive films 40′ are positioned to the film holder 10′ of the conventional film clamping device 100′, and then place the film holder 10′ on the scanning platform of the scanning device for scanning the plurality of the positive films 40′.

However, the negative film 30′ is fastened by the conventional film clamping device 100′, the conventional film clamping device 100′ clamps an outer rim of the negative film 30′, so when the conventional film clamping device 100′ clamps the negative film 30′, a middle part of the negative film 30′ is apt to bend. If a bending extent of the negative film 30′ is overly large, the negative film 30′ is caused to move out of a scanning depth of field of the scanning device, so that a scanning result will be affected.

Therefore, it is necessary to provide an innovative film clamping device that avoids the negative film from bending, and the innovative film clamping device ensures that the negative film is held within a range of a scanning depth of field.

### BACKGROUND OF THE INVENTION

The present invention generally relates to a film clamping device, and more particularly to a film clamping device which is used to fasten films to facilitate scanning the films.

### SUMMARY OF THE INVENTION

An object of the present invention is to provide a film clamping device which is used to fasten films to facilitate scanning the films. The film clamping device includes a film holder formed in a flat shape, a cap and a plurality of limiting pads. One side of the film holder defines a first fixing slot vertically penetrating through the film holder. The first fixing slot accommodates a negative film. A dimension of the cap is disposed to be cooperated with a dimension of the first fixing slot so as to be fastened to the film holder. A bottom surface of the cap is provided as a flat surface. The plurality of the limiting pads are made of elastic materials. The plurality of the limiting pads are disposed around a peripheral wall of the first fixing slot.

Another object of the present invention is to provide a film clamping device. The film clamping device includes a film holder, a cap and a plurality of limiting pads. The film holder is formed in a flat shape. One side of the film holder defines a first fixing slot vertically penetrating through the film holder. The first fixing slot accommodates a negative film. Several portions of the other side of the film holder define a plurality of second fixing slots vertically penetrating through the film holder. The plurality of the second fixing slots accommodate a plurality of positive films. A dimension of the cap is disposed to be cooperated with a dimension of the first fixing slot so as to be fastened to the film holder. A bottom surface of the cap is provided as a flat surface. The plurality of the limiting pads are made of elastic materials. The plurality of the limiting pads are disposed around a peripheral wall of the first fixing slot.

Another object of the present invention is to provide a film clamping device. The film clamping device includes a film holder, a cap and a plurality of limiting pads. The film holder is formed in a flat shape. One side of the film holder defines a first fixing slot vertically penetrating through the film holder. The first fixing slot accommodates a negative film. The first fixing slot is hollow. Several portions of the other side of the film holder define a plurality of second fixing slots vertically penetrating through the film holder. The plurality of the second fixing slots accommodate a plurality of positive films. A dimension of the cap is disposed to be cooperated with a dimension of the first fixing slot so as to be fastened to the film holder. A bottom surface of the cap is provided as a flat surface. The plurality of the limiting pads are made of elastic materials. The plurality of the limiting pads are disposed around a peripheral wall of the first fixing slot. Two sides of each end of the film holder are provided with a buckling block and a buckling groove, each two facing film holders are assembled together, when each two facing film holders are assembled, shapes and positions of the buckling blocks and the buckling grooves of two facing ends of the two facing film holders are disposed to be cooperated with each other, and the shapes and the positions of the buckling blocks and the buckling grooves of the two facing ends of the two facing film holders are disposed to be buckled with each other.

As described above, the film clamping device includes the film holder which is shown as the flat shape, the one side of the film holder defines the first fixing slot vertically penetrating through the film holder, the dimension of the cap is disposed to be cooperated with the dimension of the first fixing slot so as to be fastened to the film holder, the bottom surface of the cap is provided as the flat surface to make the negative film placed in the first fixing slot directly contact with a scan glass, and the negative film is completely flattened on the scan glass of a scanning device, so the film clamping device avoids the negative film from bending, and the film clamping device ensures that the negative film is held within a range of a scanning depth of field.

### BRIEF DESCRIPTION OF DRAWINGS

The present invention will be apparent to those skilled in the art by reading the following description, with reference to the attached drawings, in which:

FIG. 1 is a schematic diagram of a film clamping device in accordance with a preferred embodiment of the present invention, wherein the film clamping device is used for holding a negative film;

FIG. 2 is a schematic diagram of the film clamping device in accordance with the preferred embodiment of the present invention, wherein the film clamping device is used for holding a plurality of positive films;

FIG. 3 is a cross-sectional view of the film clamping device in accordance with the preferred embodiment of the present invention, wherein the film clamping device holds the negative film;

FIG. 4 is a schematic diagram that shows two film clamping devices are assembled according to the preferred embodiment of the present invention;

FIG. 5 is a perspective view of a conventional film clamping device, wherein the conventional film clamping device is used for fastening a negative film in prior art;

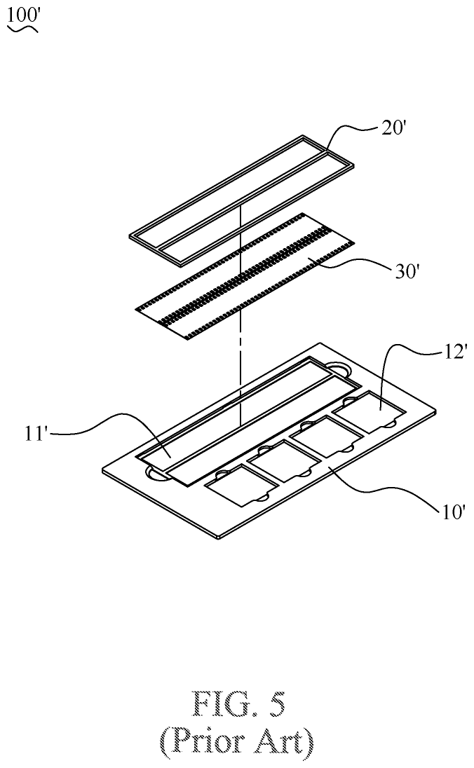

FIG. 6 is a perspective view of the conventional film clamping device, wherein the conventional film clamping device is used for fastening a plurality of positive films; and

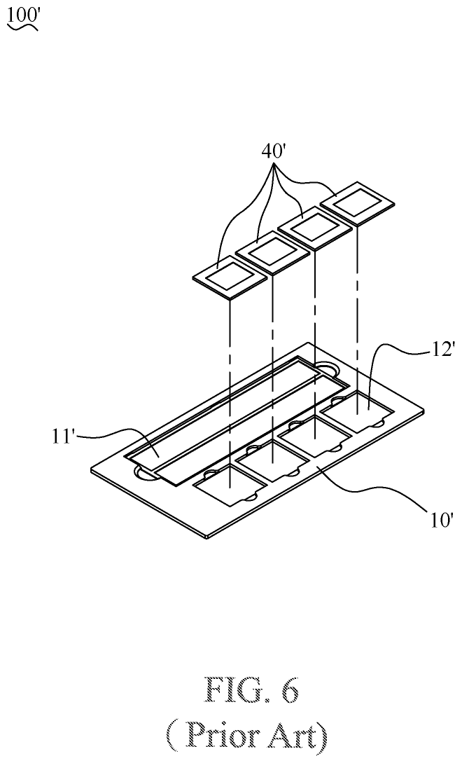

FIG. 7 is a cross-sectional diagram of the conventional film clamping device, wherein the conventional film clamping device is used for fastening the negative film.

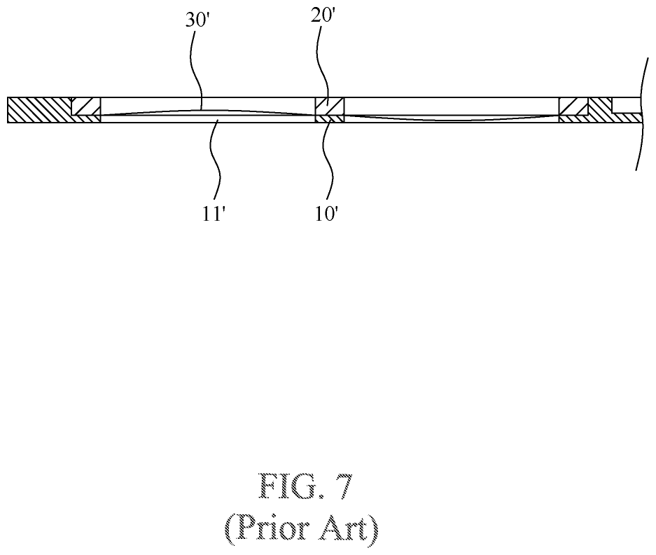

### DETAILED DESCRIPTION OF THE INVENTION

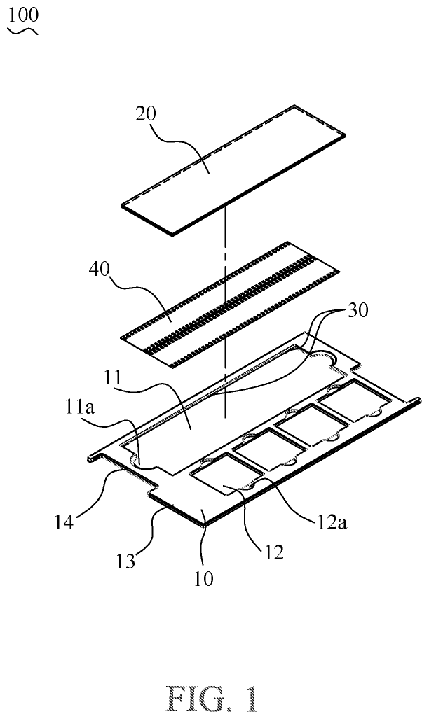

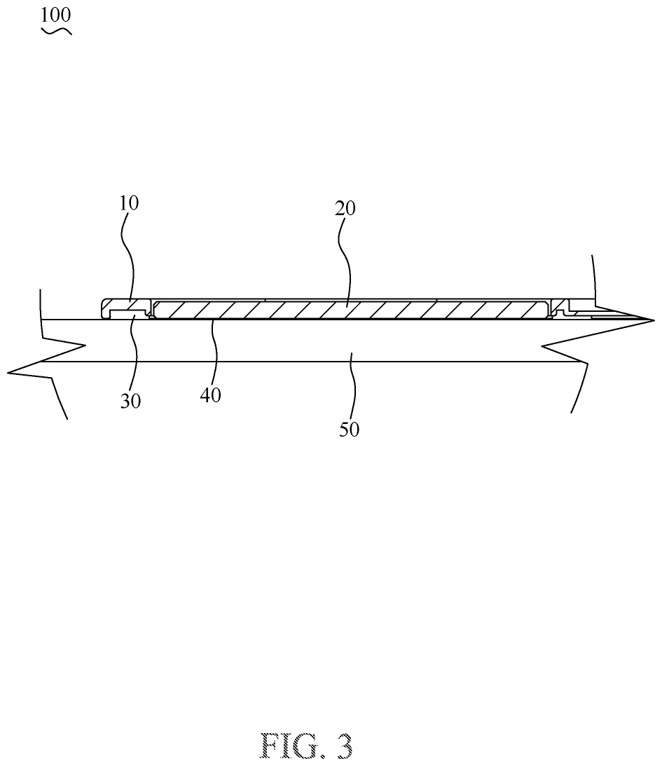

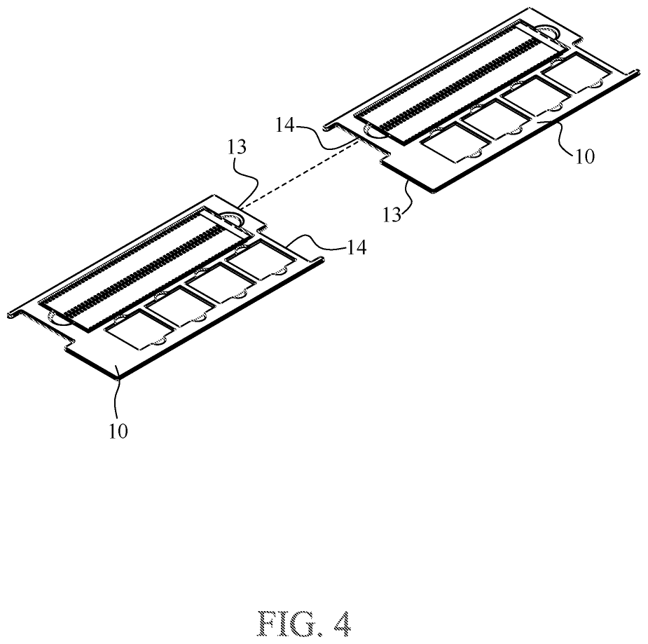

Referring to FIG. 1 to FIG. 4, a film clamping device 100 according to a preferred embodiment of the present invention is shown. The film clamping device 100 holds a plurality of positive films 60 and a negative film 40. The film clamping device 100 includes a film holder 10, a cap 20 and a plurality of limiting pads 30. The film clamping device 100 is used to fasten a plurality of films to facilitate scanning the films. The plurality of the films include the plurality of the positive films 60 and the negative film 40.

The film holder 10 is formed as a flat shape. One side of the film holder 10 defines a first fixing slot 11 vertically penetrating through the film holder 10. The first fixing slot 11 is hollow. The first fixing slot 11 is shown as a rectangular shape. The first fixing slot 11 accommodates the negative film 40. Several portions of the other side of the film holder 10 defines a plurality of second fixing slots 12 vertically penetrating through the film holder 10. The plurality of the second fixing slots 12 accommodate the plurality of the positive films 60. A dimension of the cap 20 is cooperated with a dimension of the first fixing slot 11. The cap 20 is covered to the film holder 10. The cap 20 is assembled in the first fixing slot 11. The plurality of the limiting pads 30 are made of elastic materials. The plurality of the limiting pads 30 are disposed around a peripheral wall of the first fixing slot 11 to guide the negative film 40. The negative film 40 is a roll film. The plurality of the positive films 60 are slides.

The first fixing slot 11 is defined as an opening hole which vertically penetrates through the film holder 10, so the negative film 40 which is placed in the first fixing slot 11 contacts with a scan glass 50 of a scanning device directly. In addition, a surface of the cap 20 which is in contact with the negative film 40 is disposed as a flat surface without any concave-convex portions and undulations, so that flatten the negative film 40 placed in the first fixing slot 11 completely on the scan glass 50 of the scanning device, and the negative film 40 is ensured to be without bending and tilting during a scanning process.

In addition, the film holder 10 in the present invention is disposed as a thin plate structure, so the film holder 10 may similarly bend or tilt by itself. When the film holder 10 is tilted, a gap is formed between the film holder 10 and the scan glass 50, each positive film 60 or the negative film 40 is caused to pass through the gap. In order to prevent each positive film 60 or the negative film 40 from passing through the gap during the scanning process, the plurality of the limiting pads 30 are arranged around the peripheral wall of the first fixing slot 11. Because the plurality of the limiting pads 30 are made of the elastic materials, when the plurality of the limiting pads 30 bear external forces, the plurality of the limiting pads 30 are deformed. When the film holder 10 is positioned on the scan glass 50, the plurality of the limiting pads 30 are able to keep being in contact with the scan glass 50, and the plurality of the limiting pads 30 seal up the gap between the film holder 10 and the scan glass 50, the negative film 40 is prevented from passing through the gap which is between the film holder 10 and the scan glass 50 during scanning process.

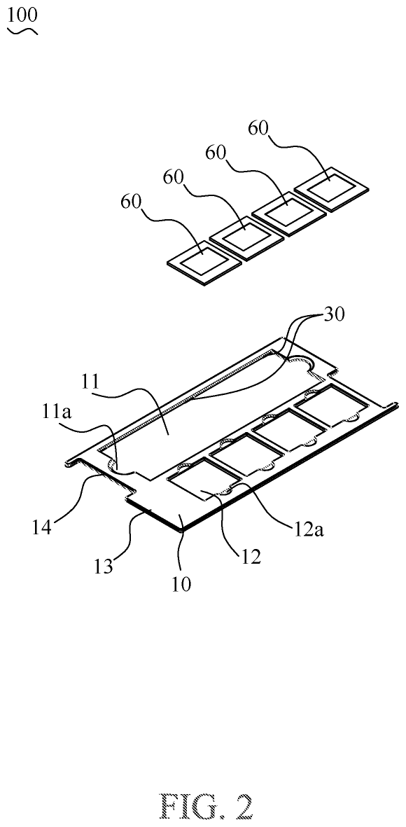

Specific steps of fastening each positive film 60 and the negative film 40 to the film clamping device 100 are described as follows. The film clamping device 100 which is used for holding the negative film 40 is shown in FIG. 1. The film clamping device 100 which is used for holding the plurality of the positive films 60 is shown in FIG. 2.

When a film which is the negative film 40 or each positive film 60 is to be scanned, firstly, the film clamping device 100 is placed on the scan glass 50 of the scanning device. Then place the film in the first fixing slot 11 or one second fixing slot 12 according to a type of the film. When the plurality of the films which include the plurality of the positive films 60 and the negative film 40, firstly, the film clamping device 100 is placed on the scan glass 50 of the scanning device. Then place the plurality of the films in different fixing slots which include the first fixing slot 11 and the plurality of the second fixing slots 12 according to the types of the films. When each positive film 60 is to be scanned, each positive film 60 is placed in the one second fixing slot 12, and each positive film 60 is fastened in the one second fixing slot 12. When the negative film 40 is to be scanned, the negative film 40 is placed in the first fixing slot 11, and the negative film 40 is fastened in the first fixing slot 11 by the plurality of the limiting pads 30, and then assemble the cap 20 into the first fixing slot 11 to flatten the negative film 40 to a surface of the scan glass 50.

Referring to FIG. 2 to FIG. 4, when the negative film 40 is bent or tilted in the first fixing slot 11 of the film holder 10, the plurality of the limiting pads 30 are disposed around the peripheral wall of the first fixing slot 11, the negative film 40 is effectively prevented from passing through the gap which is formed between the film holder 10 and the scan glass 50. When the negative film 40 is scanned, the negative film 40 is placed in the first fixing slot 11, the negative film 40 is guided in a center of the first fixing slot 11 and the negative film 40 is fixed to the center of the first fixing slot 11 by the plurality of the limiting pads 30, the plurality of the limiting pads 30 are able to keep contacting with the scan glass 50, the plurality of the limiting pads 30 seal up the gap between the film holder 10 and the scan glass 50, so that the negative film 40 is ensured to be without passing through the gap between the film holder 10 and the scan glass 50.

Referring to FIG. 1 to FIG. 4, the film clamping device 100 is provided with a snap-fit structure, when the two film holders 10 are assembled, the snap-fit structure is used to make the two film holders 10 buckled with each other, so the film clamping device 100 is extended by buckling the two film holders 10. In this preferred embodiment, two sides of each end of the film holder 10 are provided with a buckling block 13 and a buckling groove 14. One side of each end of the film holder 10 protrudes outward to form the buckling block 13, and the other side of each end of the film holder 10 is recessed inward to form the buckling groove 14. Each two facing film holders 10 are assembled together. When each two facing film holders 10 are assembled, shapes and positions of the buckling blocks 13 and the buckling grooves 14 of two facing ends of the two facing film holders 10 are disposed to be cooperated with each other, and the shapes and the positions of the buckling blocks 13 and the buckling grooves 14 of the two facing ends of the two facing film holders 10 are disposed to be buckled with each other, so that when a large number of the films are to be scanned at the same time, a plurality of the film holders 10 are able to be buckled, and the plurality of the film holders 10 are able to be combined to accommodate more films.

Referring to FIG. 1 to FIG. 4, the film holder 10 of the film clamping device 100 further includes a semicircular first retaining slot 11a vertically penetrating through the film holder 10, and a semicircular second retaining slot 12a. The first retaining slot 11a is disposed at one inner end edge of the first fixing slot 11 to allow a user to remove the negative film 40 which is placed in the first fixing slot 11. The second retaining slot 12a is disposed at one inner side edge of the second fixing slot 12 to allow the user to remove the plurality of the positive films 60 which are placed in the plurality of the second fixing slots 12. Specifically, the film holder 10 has two first retaining slots 11a and a plurality of second retaining slots 12a. The two first retaining slots 11a are disposed at two inner end edges of the first fixing slot 11. Two tops of two side walls of each second fixing slot 12 are recessed downward to form two second retaining slots 12a.

The film clamping device 100 shown above is one of embodiments of the present invention. This specification is only given as an example for an illustrative purpose, but the specification is without being limited here. According to a creation spirit of this invention and an actual usage requirement, the film clamping device 100 is able to be designed to a common film clamping device 100 which holds other numbers and sizes of the positive films 60 and the negative film 40, such as 35 mm long strip soft films, 35 mm slides, 120/220 (6×9 cm) soft films, 4×5 inch soft films, etc. The film clamping device 100 according to the present invention is able to be applied to various image processing devices, such as the scanning devices, printers, multifunctional transaction machines or fax machines.

As described above, the film clamping device 100 includes the film holder 10 which is shown as the flat shape, the one side of the film holder 10 defines the first fixing slot 11 vertically penetrating through the film holder 10, the dimension of the cap 20 is disposed to be cooperated with the dimension of the first fixing slot 11 so as to be fastened to the film holder 10, a bottom surface of the cap 20 is provided as a flat surface to make the negative film 40 placed in the first fixing slot 11 directly contact with the scan glass 50, and the negative film 40 is completely flattened on the scan glass 50 of the scanning device, so the film clamping device 100 avoids the negative film 40 from bending, and the film clamping device 100 ensures that the negative film 40 is held within a range of a scanning depth of field.

1. A film clamping device, comprising:
a film holder formed in a flat shape, one side of the film holder defining a first fixing slot vertically penetrating through the film holder, the first fixing slot accommodating a negative film;
a cap, a dimension of the cap being disposed to be cooperated with a dimension of the first fixing slot so as to be fastened to the film holder, a bottom surface of the cap being provided as a flat surface; and
a plurality of limiting pads made of elastic materials, the plurality of the limiting pads being disposed around a peripheral wall of the first fixing slot.

2. The film clamping device as claimed in claim 1, wherein the film holder is disposed as a thin plate structure.

3. The film clamping device as claimed in claim 1, wherein two sides of each end of the film holder are provided with a buckling block and a buckling groove, each two facing film holders are assembled together, when each two facing film holders are assembled, shapes and positions of the buckling blocks and the buckling grooves of two facing ends of the two facing film holders are disposed to be cooperated with each other, and the shapes and the positions of the buckling blocks and the buckling grooves of the two facing ends of the two facing film holders are disposed to be buckled with each other.

4. The film clamping device as claimed in claim 1, wherein the film holder includes a semicircular first retaining slot vertically penetrating through the film holder, the first retaining slot is disposed at one inner end edge of the first fixing slot.

5. The film clamping device as claimed in claim 4, wherein several portions of the other side of the film holder defines a plurality of second fixing slots vertically penetrating through the film holder, the plurality of the second fixing slots accommodate a plurality of positive films.

6. The film clamping device as claimed in claim 5, wherein the film holder further includes a semicircular second retaining slot, the second retaining slot is disposed at one inner side edge of the second fixing slot.

7. The film clamping device as claimed in claim 5, wherein the film holder has two first retaining slots, the two first retaining slots are disposed at two inner end edges of the first fixing slot.

8. The film clamping device as claimed in claim 7, wherein two tops of two side walls of each second fixing slot are recessed downward to form two second retaining slots.

9. The film clamping device as claimed in claim 1, wherein the negative film is a roll film.

10. The film clamping device as claimed in claim 1, wherein the first fixing slot is hollow.

11. The film clamping device as claimed in claim 1, wherein the first fixing slot is shown as a rectangular shape.

12. A film clamping device, comprising:
a film holder formed in a flat shape, one side of the film holder defining a first fixing slot vertically penetrating through the film holder, the first fixing slot accommodating a negative film, several portions of the other side of the film holder defining a plurality of second fixing slots vertically penetrating through the film holder, the plurality of the second fixing slots accommodating a plurality of positive films;
a cap, a dimension of the cap being disposed to be cooperated with a dimension of the first fixing slot so as to be fastened to the film holder, a bottom surface of the cap being provided as a flat surface; and
a plurality of limiting pads made of elastic materials, the plurality of the limiting pads being disposed around a peripheral wall of the first fixing slot.

13. A film clamping device, comprising:
a film holder formed in a flat shape, one side of the film holder defining a first fixing slot vertically penetrating through the film holder, the first fixing slot accommodating a negative film, the first fixing slot being hollow, several portions of the other side of the film holder defining a plurality of second fixing slots vertically penetrating through the film holder, the plurality of the second fixing slots accommodating a plurality of positive films;
a cap, a dimension of the cap being disposed to be cooperated with a dimension of the first fixing slot so as to be fastened to the film holder, a bottom surface of the cap being provided as a flat surface; and
a plurality of limiting pads made of elastic materials, the plurality of the limiting pads being disposed around a peripheral wall of the first fixing slot,
wherein two sides of each end of the film holder are provided with a buckling block and a buckling groove, each two facing film holders are assembled together, when each two facing film holders are assembled, shapes and positions of the buckling blocks and the buckling grooves of two facing ends of the two facing film holders are disposed to be cooperated with each other, and the shapes and the positions of the buckling blocks and the buckling grooves of the two facing ends of the two facing film holders are disposed to be buckled with each other.

14. The film clamping device as claimed in claim 13, wherein one side of each end of the film holder protrudes outward to form the buckling block, and the other side of each end of the film holder is recessed inward to form the buckling groove.
